(19) United States
(12) Patent Application Publication
(10) Pub. No.: US 2006/0085176 A1
(43) Pub. Date: Apr. 20, 2006

(54) Generating an optimized system-level simulation

(76) Inventors: Matthew Bellantoni, Brookline, MA (US); William Neifert, Arlington, MA (US); Andrew Ladd, Maynard, MA (US); Matthew Grasse, Watertown, MA (US); Mark Kostick, Boston, MA (US); Aron Atkins, Arlington, MA (US)

Correspondence Address: GOODWIN PROCTER LLP;PATENT ADMINISTRATOR, EXCHANGE PLACE, BOSTON, MA, 02109-2881, US

(21) Appl. No.: 10/965,050

(22) Filed: Oct. 14, 2004

(51) Int. Cl. G06F 17/50

(52) U.S. Cl. 703/14

(57) ABSTRACT

A system-level description that specifies functions performed by the components and interactions thereamong is divided into a plurality of functional blocks, each corresponding to a component. At least one of the functional blocks is selectively replaced with an optimized equivalent functional block, and the functional blocks and the at least one optimized equivalent functional block are interconnected in a manner consistent with the system-level description.

### FIELD OF THE INVENTION

The present invention relates generally to hardware simulation and, more specifically, to high-speed, object-oriented hardware simulations.

### BACKGROUND OF THE INVENTION

Electronic hardware design is typically performed using register transfer level (RTL) descriptions of the device being designed. Hardware description languages such as Verilog and VHDL allow hardware designers to describe the electronic devices or components that they are designing, and to have those descriptions synthesized into a form that can be fabricated.

The process of producing electronic devices is time-consuming and expensive. As a result, various simulation systems have been developed to permit hardware designs to be verified prior to actually producing an electronic device. Typically, a description of an electronic device is exercised using a simulator. The simulator generally includes a simulation kernel that runs the simulation either in software or using simulation hardware, which typically consists of a collection of programmable logic devices or specially designed processing units. Use of simulation for the purpose of verifying hardware designs is a regular part of the hardware design cycle.

Many current hardware designs are intended to be used extensively in conjunction with software applications. Due to the slow speed of many current simulators, it may be necessary to delay much of the design and testing of such software until after early versions of the actual hardware become available. As a result, software development may not be possible until relatively late in the design cycle, potentially causing significant delays in bringing some electronic devices to market.

In view of the above, it is desirable to create high-speed simulations of the system so that software developers may begin working on applications while the hardware engineers are still designing the actual implementation. Some systems have, in fact, been developed to offer operating speeds sufficient to permit software testing. In other words, using such systems, software developers can simulate the behavior of the modeled hardware in response to their code. Reaching practical simulation speeds, however, generally requires operating trade-offs. For example, a high-speed simulation may not fully model the functionality of the hardware, perhaps abstracting components to the point of being accurate in terms of interface only. As a result, such a simulation will be limited in its reflection of how the system—software and hardware—will eventually run. To improve modeling accuracy, simulations representing closer approximations of the actual devices may be introduced as the hardware components are developed. But again, due to the trade-off between capability and speed, such simulations generally run slowly and consequently limit the efficiency with which hardware and software may be co-designed.

In addition, co-developed software may nominally interact with an entire system, but operate primarily and most critically with a single device or component. Still, such devices may not operate outside the context of the entire system, which therefore must be simulated in its totality in order to accurately represent interactions with a single device.

### SUMMARY OF THE INVENTION

Software developers want to accurately simulate one or more components of a particular system before the component is fabricated. To achieve this accuracy, a software developer may recognize the centrality of such component(s) to the simulation and be willing to sacrifice the accuracy of other system components less central to software operation in order to improve overall simulation efficiency. In accordance with the present invention, a simulated hardware system runs as close to real-time as possible, preserving implementation-level detail, but allowing the developer to vary the fidelity with which different hardware components are represented. The competing demands of simulation speed and component-level accuracy are thereby balanced without compromising the utility or internal consistency of the simulation.

One aspect of the present invention involves a method for providing an optimized system-level description of a circuit including a plurality of components. A system-level description that specifies functions and interactions performed by the components is divided into a plurality of functional blocks, each corresponding to a component of the system. One or more of the functional blocks is then selectively replaced with an optimized equivalent functional block. Then the original and equivalent functional blocks are interconnected in a manner consistent with the system-level description.

Another aspect of the present invention involves an apparatus for generating an executable system-level simulation. The apparatus includes a (i) module for representing a system-level description divided into a plurality of functional blocks, (ii) instructions for selectively replacing functional blocks with optimized equivalent functional blocks, and (iii) a compiler for generating an executable optimized system-level simulation from the original and equivalent functional blocks consistent with the system-level description.

In some embodiments, the functional blocks and optimized equivalent functional blocks are compiled into respective hardware objects which may be expressed as compiled run-time code. In some embodiments, after the functional blocks and optimized equivalent functional blocks are compiled, an optimized system-level simulation is generated. In these embodiments, the optimized system-level simulation includes the compiled hardware objects and computationally implements the circuit created by the hardware objects. Generating the optimized system-level simulation may include linking the compiled hardware objects together and producing executable computer code.

In general, the optimized equivalent functional blocks embody the functions associated with the replaced functional blocks, and may also provide additional functions. However, the optimized equivalent functional blocks embody the functionality such that the optimized system-level simulation is more efficient than, but consistent with, a simulation compiled without replacing the functional blocks of the system-level description. In some versions, to keep the optimized system-level simulation consistent with a simulation compiled without replacing the functional blocks, the optimized system-level simulation may be consistent with respect to the boundaries of a system clock; in other words, functional consistency is maintained with respect to system clock boundaries but not, for example, with respect to internal transitions specific to the modeled component. Such simplification can substantially improve simulation performance. Similarly, the optimized system-level simulation may be consistent with respect to the inputs, inouts, and outputs of the system-level description or to the timing requirements of the functional blocks.

In some embodiments, all functional blocks of the system-level description are replaced with optimized equivalent functional blocks. In other embodiments, entire classes of functional blocks are replaced. In still other embodiments, replacement occurs on an ad hoc basis depending on the characteristics of each functional block.

In some embodiments, each functional block of the system-level description is represented in a hardware description language such as Verilog or VHDL. In other embodiments, each functional block may be represented in a high-level language such as C, C++, SystemC, or Java. Different practitioners of the art will choose different languages as they see fit, and the present invention is not limited in scope by a particular language's implementation.

In some embodiments, interconnecting the functional blocks to each other and to optimized equivalent functional blocks includes mapping an output of a first functional block to an input of a second functional block. In some cases, the first and second functional blocks may be the same functional block, so that an output is also utilized as an input. In some embodiments, an output or an input may be an “inout,” i.e., is utilized for both input and output. Therefore, references made herein to “input” or “output” are to be understood as including inouts. In other embodiments, the first and second functional blocks are different blocks, related by a one-to-one mapping. Interconnecting the original functional blocks and the optimized equivalent functional blocks may then include mapping outputs to inputs. In any of these embodiments, the first and/or second functional blocks may be an optimized equivalent functional block.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1A is a flowchart depicting a method for providing an optimized system-level description of a circuit in accordance with an embodiment of the invention;

FIG. 1B is a block diagram depicting input and output interconnections before and after replacing a non-optimized functional block with its optimized equivalent counterpart consistent with a system-level description in accordance with an embodiment of the invention;

FIG. 1C is a flowchart depicting a method for generating an optimized a system-level simulation of a hardware device in accordance with an embodiment of the invention;

FIG. 2 depicts a progression from device concept to an executable simulation;

FIG. 3 schematically depicts an apparatus for generating an executable system-level simulation in accordance with an embodiment of the invention; and

FIG. 4 is a block diagram of a progression from a system-level description to an optimized system-level simulation.

### DETAILED DESCRIPTION

Simulating an entire system, down to the transitions performed on each pin of each component of each device, generally requires substantial sacrifices in simulation efficiency. Every clock cycle, each device must check to see if its inputs have changed and if it must compute new outputs based on previous or current inputs. In efficient simulations of these systems, devices need not necessarily process their respective inputs on every clock edge. For example, a system may consist of a central processing unit (CPU) and a number of peripheral components that provide interface functionality. When the CPU is not interacting with a particular peripheral component, e.g., when the CPU is performing an internal calculation or interfacing with another component, a non-active component may be generally ignored and not have its clock or other inputs changed. Therefore, until the CPU is either providing inputs to the non-active component or requesting outputs from it, the component generally does not process inputs or outputs in a manner that executes synchronously with the system clock.

In addition to components executing only when they experience interaction, the interactions between components and with the system may also be abstracted to achieve efficiency. Instead of checking each input pin (via a pin-level interface) on each clock edge, a simulated device may also be transaction-accurate such that it has additional functions to represent combined operations that constitute the totality of an input or an output transaction. That is, in a system-level, transaction-oriented view, the device may perform multiple cycles of multiple pin-level transitions necessary to execute the component-level functionality of the device in response to a single system-level transaction command. For example, in a pin-level scenario where a component is reading data, the system first places data into the device inputs (which represent the pins of the device) and then toggles the system clock. The device finds data in its inputs and prepares to read from a data bus. The system toggles the system clock again and the device reads values on the data bus. Though a device may include the functionality to operate synchronously with the system clock presented in the pin-level scenario, it may also utilize a system-level transaction to read input data, e.g., a “read” command. A transaction-oriented view does not require the device to wait for each toggle of the system clock. The component may therefore not require execution on each clock cycle (i.e., operation that is synchronous with the system clock) but rather, only as necessary to ensure presentation of the appropriate outputs on its output pins on the correct clock cycle. By sacrificing internal simulation accuracy and ignoring non-active components, the overall efficiency of the system-level simulation is increased without compromising system-level accuracy. Care must be taken, however, not to abstract too much of the system for the sake of efficiency, since accuracy is generally lost as efficiency is obtained. The degree of allowable abstraction is determined both at the device level, based on the criticality of each device to the software under development, and the system level, where overall execution accuracy must ordinarily be maintained.

Broadly, the present invention achieves this balance of accuracy and efficiency by selectively replacing functional blocks, e.g., software code representing devices or components, of a system with optimized versions of the devices or components (i.e., optimized equivalent functional blocks) in a system-level description. A functional block may be optimized toward accuracy (by modeling its functionality at the device level) or toward efficiency (by combining or abstracting operations or modeling its functionality at the system level). An optimized functional block may be more efficient than an existing functional block, or it may be more cycle accurate. In a preferred embodiment, the optimized functional blocks are optimized with respect to the efficiency and execution speed of the simulation.

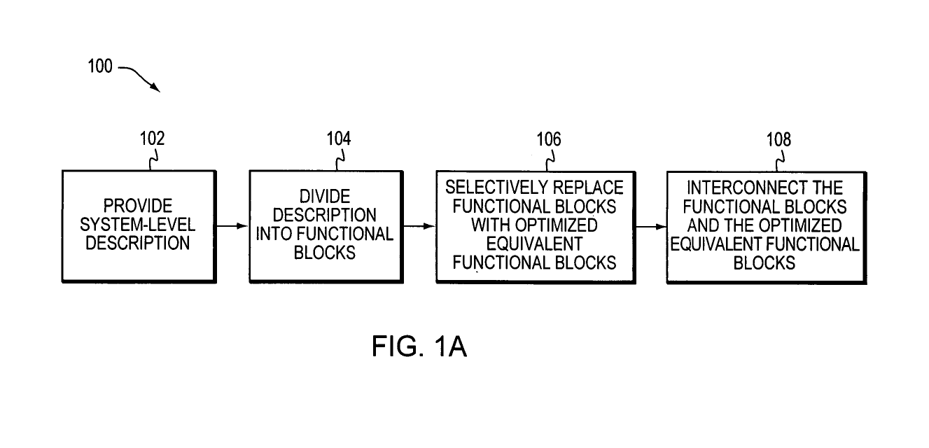

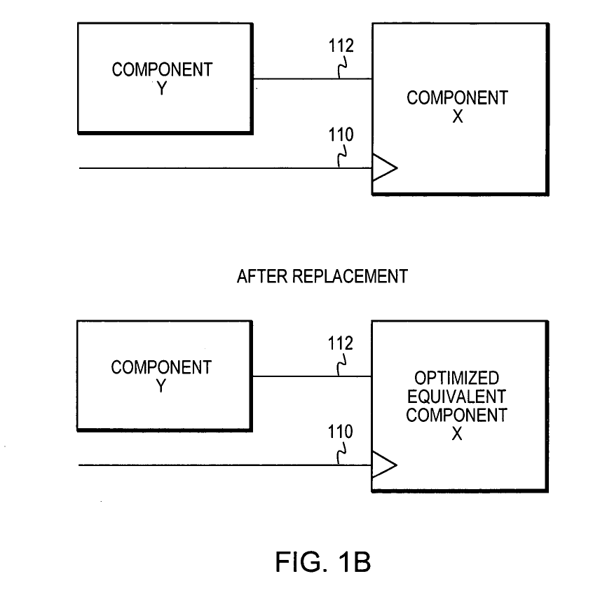

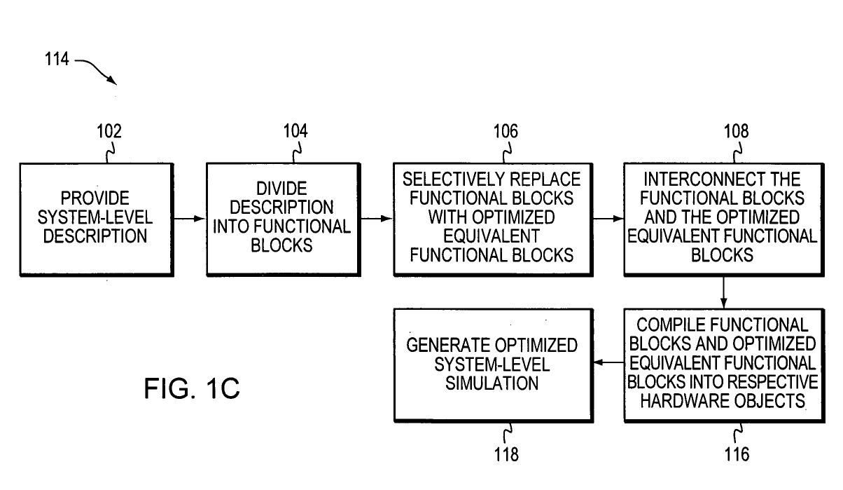

FIG. 1A depicts a method for providing an optimized system-level description of a circuit in accordance with an embodiment of the invention. The method 100 begins by providing a system-level description (step 102). The system level description includes software representations of components and devices as well as connections thereamong. These components may be processors, bus controllers, memories, and peripheral interface components, or any number of other software representations of devices found in an electrical system such as a computer. Though a computer system is provided as an example, any electronic system may be modeled and simulated in accordance with the present invention.

The system-level description is then divided into functional blocks (step 104). Software representations of components may be referred to generally as functional blocks because they represent sections of code that generally perform one or more functions. In some embodiments, the dividing step involves determining which portions of the system-level description pertain to the components and which portions pertain to other aspects of the simulation, e.g., connections between the components, simulation control managers and clocking objects. For example, the system-level description may contain clock variables and initialization functions that need not be optimized or do not pertain to the simulation outside of preparing it for execution. A distinction is then ascertainable between the individual functional blocks and the simulation-supporting code.

Once the system-level description is divided into functional blocks (step 104), some of the functional blocks are replaced (step 106) with optimized equivalent functional blocks. Again, these optimized functional blocks may be optimized for accuracy or efficiency yet retain “equivalent” functionality of the original functional block at a desired level of abstraction. In some embodiments, as few as one functional block is replaced with an optimized functional block. In these embodiments, simulation performance bottlenecks created by a single device may be overcome while maintaining the device-level accuracy of the rest of the system. In other embodiments, two or more functional blocks are replaced with optimized equivalent functional blocks. In these embodiments, devices or components deemed less critical to the accuracy of the simulation are replaced. For example, a standard counter or clock object may be replaced without affecting the usefulness of the simulation, since the components are conventional and the specifics of their internal transitions are unlikely to affect other devices or be of interest to a software developer. Though both counters and clocks are generally necessary for accurate simulation in terms of intra-system timing, such components may be replaced with optimized versions to improve simulation speed and efficiency. In still other embodiments, all functional blocks are replaced with optimized equivalent functional blocks. In these embodiments, general system-level performance is measured without regard to operational accuracy at the system or device level. This allows software developers to write applications that interface with device drivers to the functional blocks. As a result, it may not be necessary to accurately represent, for example, what pin is set at which clock cycle, only that a specified input is fed into the functional block and an output is returned.

Once optimized functional blocks replace the selected functional blocks (step 106), the remaining functional blocks and the optimized functional blocks are interconnected (step 108) in accordance with the system-level description. Referring to FIG. 1B, if original component X has a clock input 110 and an input 112 from the output of component Y, then the optimized equivalent of component X would have a clock input 110 and an input 112 from the output of non-optimized original component Y because interconnections are made in accordance with the system-level description. These interconnections are described in co-pending U.S. application Ser. No. 10/820,643 entitled “System-Level Simulation of Interconnected Devices,” the entire disclosure of which is incorporated herein by reference.

These interconnections may map, i.e., connect one to another, from an output of a first functional block to an input of a second functional block or an optimized equivalent functional block. Naturally, the converse may be true, where the output of an optimized equivalent functional block may interconnect to the input of a non-optimized original functional block. In some cases, as with hardware, the output of a functional block may in fact also be an input to that same functional block. This approach is described in full in the above-mentioned '643 application. Additionally, an output of a functional block or an optimized equivalent functional block may map to two or more functional blocks (or optimized equivalent functional blocks, or a combination of optimized equivalent and non-optimized functional blocks). Referring back to FIG. 1A, upon completion of the method 100, an optimized system-level description including functional blocks and optimized equivalent functional blocks has been provided.

FIG. 1C depicts a method 114 for generating an optimized a system-level simulation of a hardware device in accordance with an embodiment of the invention. The method 114 includes steps 102-108, which create an optimized system-level description, and following this, the functional blocks and optimized equivalent functional blocks are compiled (step 116) into respective hardware objects which are expressed as run-time code. This run-time code may be object code, suited for incorporation into a larger system, or a standalone executable that computationally implements the functionality of the device or component to which it corresponds.

In some embodiments, after the original and optimized equivalent functional blocks are compiled into hardware objects (step 116), an optimized system-level simulation is generated (step 118) to computationally implement the entire system. Generating the simulation (step 118) generally involves linking the compiled hardware objects together according to a circuit design and producing executable computer code. The simulation therefore includes the hardware objects to computationally implement the modeled circuit. In some embodiments, the circuit is a single hardware object (i.e., an output may also serve as an input). In other embodiments, the circuit is a plurality of hardware objects cooperating electronically. Regardless, the circuit is implemented consistent with the system-level description with respect to the interconnection of its components (see step 108).

In some embodiments, the optimized equivalent functional blocks of the description embody the functions associated with the replaced functional blocks. Additionally, the optimized equivalent functional blocks include additional functions, such that the optimized system-level simulation is more efficient than, but consistent with, a simulation compiled without replacing the functional blocks of the system-level description. Therefore, a system-level simulation generated from the optimized system-level description, which in turn is compiled using optimized equivalent functional blocks, will have the same system-level execution order and inter-component timing constraints, yet will operate more efficiently than a simulation derived from a description that does not incorporate optimized equivalent functional blocks. In some embodiments, the optimized system-level simulation is fully consistent with a non-optimized simulation with respect to the boundaries of a system clock. In other embodiments, the optimized system-level simulation is fully consistent with a non-optimized simulation with respect to the inputs, inouts, and outputs of the system-level description. In other embodiments, the optimized system-level simulation is fully consistent with a non-optimized simulation with respect to the timing requirements of the functional blocks as in the system-level description.

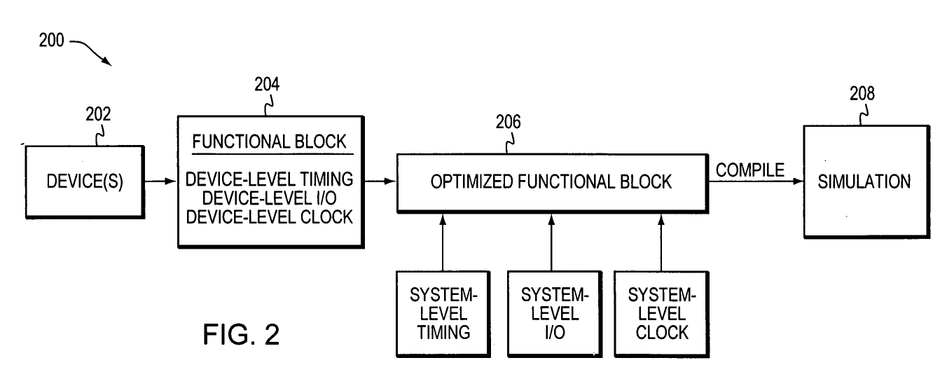

FIG. 2 depicts the progression (indicated generally at 200) from device concept to an executable simulation. The progression 200 begins with the concept of a device 202. The developer defines the characteristics of a device 202 and describes the device 202 in a hardware description language such as Verilog or VHDL. The description represents a functional block 204 of code, i.e., a coded representation of the device's envisioned functionality. When writing the functional block 204, the developer includes device characteristics such as constraints, inputs, and outputs. In some embodiments, device constraints may correspond to real-world physical constraints, e.g., an addition function may require two clock cycles to read in input, compute the result, and produce an output. In other embodiments, these constraints may exist to provide desired results or behavior—for example, in the case of a component configured to conform to the PCI bus standard, asserting a TRDY# (“target ready”) signal in response to receiving an IRDY# (“initiator ready”) signal. These constraints and implementations lead to a “device-centric” view of the software. For example, a functional block 204 may have device-level timing, e.g., requiring two clock cycles to perform an addition, just like the physical device. A functional block 204 may also have device-level I/O, producing a certain output when provided a certain input, or device-level clock interactions such as processing inputs on every fourth clock cycle due to the internal device configuration. In the latter case, the functional block still executes every clock cycle, but it does not process inputs until the fourth clock cycle.

A functional block 204 may also be optimized and viewed at a system level, i.e., as an optimized functional block 206. For example, a functional block that processes inputs every fourth clock cycle need only execute every fourth clock cycle instead of every clock cycle. From a system standpoint, input need not be provided to the functional block 204 until the fourth clock cycle because the input is not processed until then anyway. Using this “system-centric” view, an optimized functional block may forgo device-level constraints in favor of system-level timing, I/O, and clocking. For example, at the system level, a particular transaction need not take a particular number of clock cycles to perform. Instead, the system-level view of timing may dictate only that input is provided at one point in time and output is received at a later point in time (as opposed to a set number of clock cycles separating these operations). Additionally the optimized functional block 206 may also have system-level I/O operations (e.g., “read data,” rather than the more granular operations involved, such as asserting a signal, checking a bus, transferring the data in, etc.) and clocking operations (e.g., as described above with reference to executing every fourth clock cycle).

Once the optimized functional block 206 is created from the functional block 204, a compiler (not shown) compiles the optimized functional block 206 in accordance with other functional blocks (which may or may not be optimized) to produce an executable simulation 208. The optimized executable simulation 208 is described in greater detail below.

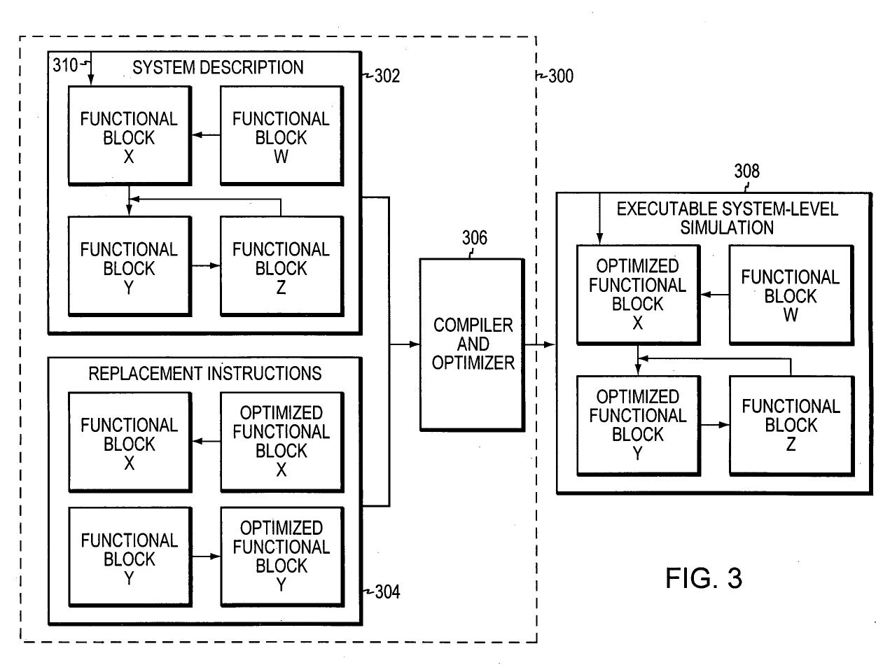

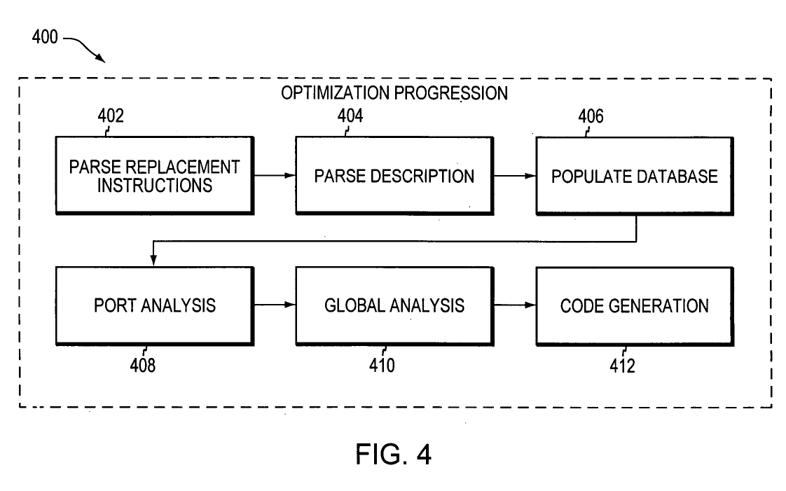

FIG. 3 depicts an apparatus for generating an executable system-level simulation in accordance with an embodiment of the invention. The apparatus 300 is preferably implemented in a general-purpose computer and includes a module for representing a system-level description 302, instructions 304 for selectively replacing functional blocks with optimized equivalent functional blocks, and a compiler 306 for generating an executable optimized system-level simulation 308. The components 302, 304, 306 are generally realized as executable program instructions that implement the functions described below when executed by a conventional CPU. The instructions may be stored on a mass storage device, such as a hard disk and/or CD-ROM, until transferred into Random Access Memory for execution. Briefly, the compiler 306 reads in the system-level description 302 and the replacement instructions 304. During compilation, described in detail in reference to FIG. 4, the compiler 306 replaces the functional blocks with optimized equivalent functional blocks based on the replacement instructions 304, and generates an executable system-level simulation 308.

In one embodiment, the module for representing a system-level description 302 is divided into a plurality of functional blocks (indicated as W, X, Y, and Z, generally “functional blocks”), with each functional block representing one or more hardware components linked to the system-level description 302. In some embodiments, the functional blocks are linked to the system description 302 in terms of timing coordination. In these embodiments, the functional block receives a signal 310 from the system clock as input, and executes generally synchronously with the system clock. In some embodiments, the functional blocks may be linked to system transactions such that when a specific action is performed on or by the system, the system delegates the action to the functional block. For example, when a computer as a system is asked to perform an addition function, that addition may be delegated to a math co-processor.

In one embodiment, the apparatus includes instructions 304 for selectively replacing functional blocks with optimized equivalent functional blocks (optimized functional blocks X and Y, generally “optimized equivalent functional blocks”). These replacement instructions 304 include a list of functional blocks to replace and may be stored in a file, a database, or passed into the compiler as parameters during compilation. In some embodiments, when the replacement instructions are parsed, a library is searched and optimized equivalent functional blocks are identified. In these embodiments, the optimized equivalent functional block to use for replacement is chosen based on a pre-programmed similarity to a class of devices. For example, optimized counter X may be suitable for replacing all counters because it returns generally the same outputs as conventional counters and has timing requirements similar to those expected by counters as a general class of devices.

In some embodiments, the replacement instructions 304 further specify the characteristics of the optimized equivalent functional blocks that will replace the functional blocks. Still referring to FIG. 3, the replacement instructions 304, in some embodiments, may define the differences between the unmodified functional block and the modified functional block that will replace it. Alternatively, the replacement instructions 304 may identify a particular optimized functional block from a stored library of available blocks. Replacement instructions may be specific to a particular functional block to be replaced, or may operate on an entire class of functional blocks, e.g., “counters shall each be replaced by an optimized counter X; buses shall each be replaced with an optimized bus Y.” Specifying which optimized functional blocks are to be used provides the developer a level of control over which aspects of the system will be optimized. It should be noted that the foregoing replacement instructions are purely illustrative and in practice, one skilled in the art may instead use filenames, class names, or other means of identifying blocks or portions of code to be replaced.

The compiler 306 of the apparatus 300 generates an executable optimized system-level simulation 308 from the functional blocks and the optimized equivalent functional blocks consistent with the system-level description 302. In some embodiments, the compiler 306 generates executable run-time code for each of the functional blocks. In some of these embodiments, each functional block is represented before compilation in a hardware description language such as Verilog or VHDL. Alternatively, each functional block may be represented before compilation in a high-level language such as C, C++, SystemC, or Java. When the simulation 308 is generated, the optimized equivalent functional blocks embody the functions associated with the replaced functional blocks, and possibly additional functions, such that the optimized system-level simulation 308 is more efficient than, but consistent with, a simulation compiled without replacing the functional blocks of the system-level description 302. For example, in some embodiments, the executable optimized system-level simulation 308 is fully consistent with respect to the boundaries of a system clock. In other embodiments, the optimized system-level simulation 308 is fully consistent with respect to the inputs, inouts, and outputs of the system-level description 302. In still other embodiments, the optimized system-level simulation 308 is fully consistent with respect to the timing requirements of the functional blocks. As indicated, the relationships between the optimized functional blocks and the functional blocks included in the system-level simulation are consistent with the relationships between functional blocks of the system-level description 302.

FIG. 4 depicts a progression 400 from a system-level description 302 to an optimized system-level description that will be used in the generation of an optimized system-level simulation 308. In one embodiment, the compiler 306 begins the compilation step by parsing (step 402) the replacement instructions 304. Parsing may be done by any number of text parsing tools such as the Cheetah Verilog Analyzer provided by Interra Technologies, Inc. of Santa Clara, Calif. Parsing the replacement instructions 304 first allows the compiler 306 to “know” ahead of time which functional blocks will be replaced if encountered in the system-level description 302. Once the replacement instructions 304 are parsed, the system-level description 302 is similarly parsed (step 404) to divide it into functional blocks. At this point, the system-level description 302 represents both the system level, specifying one or more components that cooperate to perform functions, as well as the component level, specifying the individual functional blocks corresponding to the components of the system. Once the system-level description 302 is parsed (step 404), a database of the system components is populated (step 406) with information about the components. The information about the components/functional blocks (such as on which clock cycles a component executes) is stored (step 406) as data structures within the database, in a format that is queryable during port and global analysis (steps 408, 410 respectively, described below). Additionally, during database population, “flow nodes” are established between components of the system, indicating the signal flow and interactions between components. The database and its population (step 406) is described more fully in co-pending U.S. application Ser. No. 10/703,406 entitled “Generation of Software Objects from a Hardware Description,” the entire disclosure of which is incorporated herein by reference. The database may reside in any one of a file, a portion of memory, or a relational database.

Next, the ports of each component/functional block are analyzed (step 408) to determine the inputs, inouts, and outputs of each functional block. At this stage, the data structure within the database representing each functional block specifies when it executes (timing information), what it will need to execute (inputs), and what it will produce upon execution (outputs). Additionally, in some embodiments, optimizations are performed during port analysis (step 408). For example, if a particular functional block has GROUND as an input, rather than checking for a signal on that input during each clock cycle the functional block is executing, a zero-voltage signal may always be simulated, effectively removing an unnecessary conditional step from the simulation. These optimizations, performed for each functional block, will generally increase the efficiency of the system as whole. After the ports of the functional blocks are analyzed (step 408), the system at the system level is analyzed (global analysis, step 410). Further optimizations may be performed such as indicating that the device may be ignored while not being interacted with (as described above) as well as analyzing the interactions between functional blocks. For example, suppose a functional block has two inputs in addition to its clock input. During port analysis (step 408), the functional block's inputs were not optimized because inputs generally cannot be predetermined at the component level. At the system level, however, it may be determined that this functional block receives those two inputs from other functional blocks, each of which always produces a particular signal. As a result, at the system level, this functional block may have the two inputs optimized such that the functional block no longer needs to determine the input on those terminals (since, once again, the input is fully determined by the operations of the other functional blocks).

A functional block may also have inputs that serve to configure it for a particular function based on the simulation of the device's intended interaction with the system and other components. During global analysis (step 410), the functional block may be optimized to perform only the function for which it is configured in the context of the simulating the system. Functionality that the functional block may possess at the device level, yet is now configured not to perform, may then be removed from the functional block, again reducing the component's complexity. For example, a general-purpose memory interface may be architected at the component level to support multiple memory timing configurations. When incorporated into a system with a set timing configuration, the exact timing of the memory interface does not change during simulation. Once the system timing is known, the memory interface may be optimized during the system-level analysis (step 410) to discard the logic that supports alternate timing configurations (since the alternate logic is no longer necessary).

Once the system-level analysis (step 410) is complete, a code framework representing the optimizations and the functional block substitutions is generated (step 412). The code framework includes object code representing the optimized equivalent functional blocks, an optimized system-level description, as well as interconnections between the original and optimized functional blocks and the system. As indicated in FIG. 3, the compiler 306 then compiles this framework, using compilation techniques known in the art, and links in supporting libraries to generate the executable system-level simulation 308.

From the foregoing, it will be appreciated that the systems and methods provided by the invention afford an efficient method for providing an optimized system-level description and an apparatus for generating an executable system-level simulation.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for providing an optimized system-level description of a circuit comprising a plurality of components, the method comprising the steps of:
providing a system-level description specifying functions performed by the components and interactions thereamong;
dividing the system-level description into a plurality of functional blocks, each functional block corresponding to a component;
selectively replacing at least one of the functional blocks with an optimized equivalent functional block; and
interconnecting the functional blocks and the at least one optimized equivalent functional block in a manner consistent with the system-level description.

2. The method of claim 1 further comprising the step of compiling all functional blocks and optimized equivalent functional blocks into respective hardware objects.

3. The method of claim 2 wherein the hardware objects are expressed as compiled run-time code.

4. The method of claim 2 further comprising the step of generating an optimized system-level simulation comprising the hardware objects and computationally implementing the circuit.

5. The method of claim 4 wherein the generating step comprises linking the compiled hardware objects together and producing executable computer code.

6. The method of claim 4 wherein the optimized equivalent functional blocks embody the functions associated with the replaced functional blocks as well as additional functions such that the optimized system-level simulation is more efficient than, but fully consistent with, a simulation compiled without replacing the functional blocks of the system-level description.

7. The method of claim 6 wherein the optimized system-level simulation is fully consistent with a simulation compiled without replacing the functional blocks of the system-level description with respect to the boundaries of a system clock.

8. The method of claim 6 wherein the optimized system-level simulation is fully consistent with a simulation compiled without replacing the functional blocks of the system-level description with respect to the inputs, inouts, and outputs of the system-level description.

9. The method of claim 6 wherein the optimized system-level simulation is fully consistent with a simulation compiled without replacing the functional blocks of the system-level description with respect to the timing requirements of the functional blocks.

10. The method of claim 1 wherein all functional blocks of the system-level description have been replaced with optimized equivalent functional blocks.

11. The method of claim 1 wherein the replacing step comprises determining optimized equivalent functional blocks based on a list of functional blocks to be replaced.

12. The method of claim 1 wherein each functional block is represented in at least one hardware description language.

13. The method of claim 12 wherein the hardware description language comprises at least one of Verilog instructions and VHDL instructions.

14. The method of claim 1 wherein each functional block is represented in at least one high-level language.

15. The method of claim 14 wherein the high-level language comprises at least one of C, C++, SystemC, and Java.

16. The method of claim 1 wherein the interconnecting step comprises mapping an output of a first functional block to an input of a second functional block.

17. The method of claim 16 wherein the first functional block and the second functional block are the same functional blocks.

18. The method of claim 16 wherein at least one of the first functional block and the second functional block is an optimized equivalent functional block.

19. The method of claim 1 wherein the interconnecting step comprises mapping an output of a first functional block to an input of a plurality of functional blocks.

20. The method of claim 19 wherein at least one of the first functional block and the plurality of functional blocks is an optimized equivalent functional block.

21. An apparatus for generating an executable system-level simulation, comprising:
a module for representing a system-level description divided into a plurality of functional blocks, each functional block representing at least one hardware component linked to the system-level description;
instructions for selectively replacing functional blocks with optimized equivalent functional blocks; and
a compiler for generating an executable optimized system-level simulation from the functional blocks and the optimized equivalent functional blocks consistent with the system-level description.

22. The apparatus of claim 21 wherein the optimized equivalent functional blocks embody the functions associated with the replaced functional blocks as well as additional functions such that the optimized system-level simulation is more efficient than, but fully consistent with, a simulation compiled without replacing the functional blocks of the system-level description.

23. The apparatus of claim 22 wherein the executable optimized system-level simulation is fully consistent with a simulation compiled without replacing the functional blocks of the system-level description with respect to the boundaries of a system clock.

24. The apparatus of claim 22 wherein the optimized system-level simulation is fully consistent with a simulation compiled without replacing the functional blocks of the system-level description with respect to the inputs, inouts, and outputs of the system-level description.

25. The apparatus of claim 22 wherein the optimized system-level simulation is fully consistent with a simulation compiled without replacing the functional blocks of the system-level description with respect to the timing requirements of the functional blocks.

26. The apparatus of claim 21 wherein the compiler further generates executable run-time code for each of the functional blocks.

27. The apparatus of claim 21 wherein each functional block is represented in a hardware description language.

28. The apparatus of claim 27 wherein the hardware description language comprises at least one of Verilog instructions and VHDL instructions.

29. The apparatus of claim 21 wherein each functional block is represented in at least one high-level language.

30. The apparatus of claim 29 wherein the high-level language comprises at least one of C, C++, SystemC, and Java.

31. The apparatus of claim 21 wherein the instructions comprise a list of functional blocks to replace.

32. The apparatus of claim 31 wherein the instructions further comprise optimized equivalent functional blocks to replace the functional blocks with.
